(19) United States
(12) Patent Application Publication
(10) Pub. No.: US 2012/0101707 A1
(43) Pub. Date: Apr. 26, 2012

(54) METHOD FOR OPERATING AN INJECTOR

(76) Inventors: Helerson Kemmer, Vaihingen (DE); Holger Rapp, Ditzingen (DE); Anh-Tuan Hoang, El Paso, TX (US); Achim Deistler, Ludwigsburg (DE)

(21) Appl. No.: 13/264,129

(22) PCT Filed: Mar. 18, 2010
(86) PCT No.: PCT/EP2010/053503

§ 371 Date: Dec. 22, 2011

(30) Foreign Application Priority Data
Apr. 20, 2009 (DE) 10 2009 002 483.2

(51) Int. Cl. F02D 41/30

(52) U.S. Cl. 701/103

(57) ABSTRACT

A method for operating an injector, in particular of an internal combustion engine of a motor vehicle, in which a component of the injector, in particular a valve needle, is driven with the aid of an electromagnetic actuator. According to the present invention, a variable which characterizes the acceleration of a movable component of the electromagnetic actuator, in particular of an armature of the electromagnetic actuator, is formed as a function of at least one electrical operating variable of the electromagnetic actuator, and an operating state of the injector is deduced as a function of the variable which characterizes the acceleration.

### BACKGROUND OF THE INVENTION

### Field Of The Invention

The present invention relates to a method for operating an injector, in particular of an internal combustion engine of a motor vehicle, in which a component of the injector, in particular a valve needle, is driven with the aid of an electromagnetic actuator.

### BRIEF SUMMARY OF THE INVENTION

The object of the present invention is to provide an improved operating method of the aforementioned type in which precise information concerning an operating state of the injector is obtained without using additional sensor systems for monitoring the injector.

In the operating method of the aforementioned type, this object is achieved according to the present invention in that a variable which characterizes the acceleration of a movable component of the electromagnetic actuator, in particular of an armature of the electromagnetic actuator, is formed as a function of at least one electrical operating variable of the electromagnetic actuator, and an operating state of the injector is deduced as a function of the variable which characterizes the acceleration.

According to the present invention, it has been recognized that in multiple different operating states or transitions between these operating states, a variable which characterizes the acceleration of a movable component of the electromagnetic actuator, in particular the armature, has a value and/or a time curve which denotes the operating state or the state transition so that precise information concerning an operating state of the injector may be obtained based on the consideration according to the present invention of the variable which characterizes the acceleration.

In contrast to conventional methods which focus on evaluating a speed of a movable component, the acceleration-based method according to the present invention advantageously allows information concerning an operating state of the injector to be obtained, even when the force is transmitted from the electromagnetic actuator to the valve needle with the aid of a complex mass system which does not provide a simple, rigid mechanical coupling between the armature and the valve needle.

Tests by the present applicant have shown that characteristic values or time curves result for a variable which characterizes the acceleration, depending on the operating state of the injector, due to different interactions of individual components of a mass system containing the valve needle and the armature, so that on this basis conclusions may advantageously be drawn with high accuracy concerning the operating state of the injector.

In one particularly advantageous specific embodiment of the method according to the present invention, the valve needle is acted on by elastic force, preferably in a closing direction of the valve needle, and the armature is connected to the valve needle in such a way that the armature is movable with a nonvanishing mechanical play relative to the valve needle in relation to a direction of motion of the valve needle, and based on a characteristic feature of the variable which characterizes the acceleration of the armature it is deduced that the armature detaches from the valve needle.

In this configuration according to the present invention, the striking of the valve needle on its associated valve seat (closing point in time) may be identified in a particularly advantageous manner, since the armature detaches from the valve needle by making use of the existing mechanical play which is reflected in a corresponding change in acceleration of the armature. In the present specific embodiment of the operating method according to the present invention, this change in acceleration of the armature results due to the fact that after the armature has detached from the valve needle, the valve needle, which is still acted on by elastic force, no longer exerts force on the armature. Accordingly, the armature moves by itself, in contrast to the valve needle, initially further in the closing direction, but from that point on with a smaller acceleration. Conventional methods which are based solely on evaluating the speed of the armature do not allow the closing point in time to be identified for the present configuration. In contrast, by making use of the variable which characterizes the acceleration of the armature, the method according to the present invention allows precise information concerning when the armature detaches from the valve needle, or when the valve needle has reached its closing position in the region of the valve seat.

In another preferred specific embodiment of the operating method according to the present invention, an actuator voltage which is present at a solenoid of the electromagnetic actuator is used as the electrical operating variable of the electromagnetic actuator, and the first time derivative of the actuator voltage is formed as the variable which characterizes the acceleration of the armature. For example, based on the appearance of a local minimum of the first time derivative of the actuator voltage, it may advantageously be deduced that the armature detaches from the valve needle.

A very particularly simple and reliable evaluation of the variable which characterizes the acceleration is possible in another advantageous variant of the present invention when an actuator current which flows through the solenoid is injected at a predefinable value. It is particularly advantageous to inject an actuator current which is constant over time, more preferably a vanishing actuator current.

As an alternative to the above-described use of the actuator voltage, an actuator current which flows through a solenoid of the electromagnetic actuator may be used to ascertain on this basis the variable which characterizes the acceleration of the armature—in the present case, the first time derivative of the actuator current.

In another advantageous specific embodiment of the operating method according to the present invention, on the basis of the appearance of a local maximum of the first time derivative of the actuator current it is deduced that the armature detaches from the valve needle.

As an alternative or in addition to the above-described consideration of local extremes of the variable which characterizes the acceleration, it is also possible to compare a time curve of the variable which characterizes the acceleration to a predefined reference curve, or to identify other features, for example an inflection in the time curve, or the like.

A particularly precise ascertainment of the operating state of the injector results when, in the case of detection of the actuator current, an actuator voltage which is present at the solenoid of the electromagnetic actuator is injected at a predefinable value, in particular zero, which may be achieved by appropriately controlling a control unit output stage which activates the injector.

In another very advantageous variant of the present invention, it is provided that a first electrical operating variable of the electromagnetic actuator is detected and supplied to an observer element which simulates the electromagnetic actuator without taking into account the effect that an armature motion has on electrical operating variables of the electromagnetic actuator, the observer element ascertaining an observed second electrical operating variable of the electromagnetic actuator, and the observed second electrical operating variable being compared to a detected second electrical operating variable, and the variable which characterizes the acceleration being ascertained as a function of the comparison result.

According to the present invention, it has been recognized that the comparison result obtained using the observer element contains important information concerning an operating state of the injector, and may therefore be advantageously used for ascertaining opening and/or closing points in time of the injector.

In contrast to conventional methods, which are able to identify only an “electrical” opening point in time or closing point in time by evaluating the trigger variables of the injector or its electromagnetic actuator, the operating method according to the present invention allows, due to the evaluation of the variable which characterizes the acceleration, the precise ascertainment of an actual hydraulic opening or closing point in time, in which the valve needle lifts off its valve seat or rests again on its valve seat.

Of particular importance is the implementation of the operating method according to the present invention in the form of a computer program which may be stored on an electronic or optical memory medium, and which may be executed by a control and/or regulating device for an internal combustion engine, for example.

Further advantages, features, and particulars result from the following description in which various exemplary embodiments of the present invention are illustrated with reference to the drawing. The features mentioned in the claims and in the description in each case may be essential to the present invention, alone or in any given combination.

### BRIEF DESCRIPTION OF THE DRAWINGS

FIG. 1 shows a schematic illustration of an internal combustion engine having multiple injectors operated according to the present invention.

FIGS. 2a through 2c schematically show a detailed view of an injector from FIG. 1 in three different operating states.

FIG. 3 shows a simplified flow chart of one specific embodiment of the method according to the present invention.

FIG. 4 shows a time curve of operating variables of the injector which are considered according to the present invention.

FIG. 5 shows another time curve of operating variables of the injector which are considered according to the present invention.

FIG. 6 shows a simple equivalent electrical circuit diagram of the electromagnetic actuator of the injector according to FIG. 2a.

FIG. 7 shows a block diagram which corresponds to the equivalent circuit diagram according to FIG. 6.

FIG. 8 shows a block diagram of a method for ascertaining a correcting quantity, using an observer element according to FIG. 7.

### DETAILED DESCRIPTION OF THE INVENTION

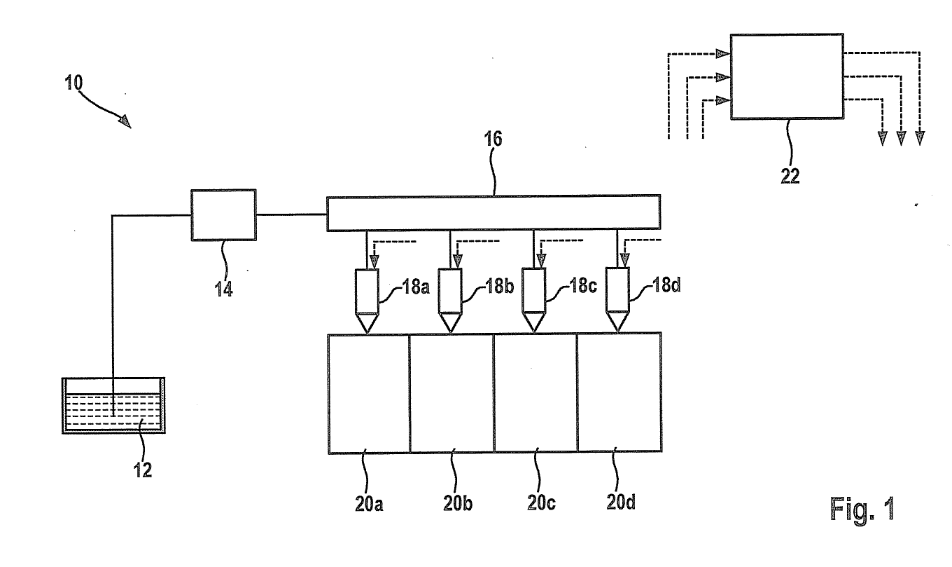

An internal combustion engine is denoted overall by reference numeral 10 in FIG. 1. The internal combustion engine includes a tank 12 from which a supply system 14 delivers fuel into a common rail 16. Multiple electromagnetically activated injectors 18a through 18d are connected to the common rail, and inject the fuel directly into combustion chambers 20a through 20d, respectively, associated with the injectors. The operation of internal combustion engine 10 is controlled and regulated by a control and regulating device 22 which also activates injectors 18a through 18d, among other elements.

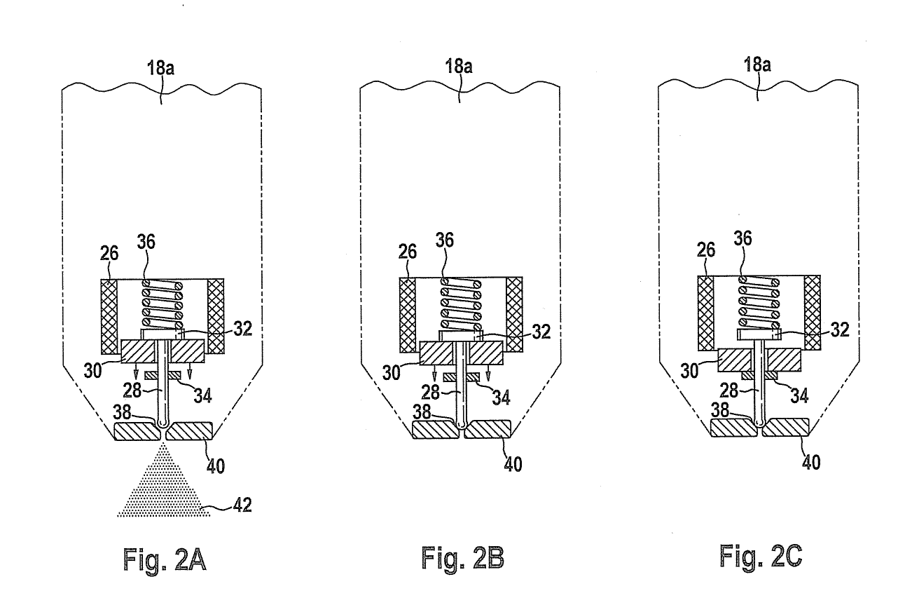

FIGS. 2a through 2c schematically show injector 18a according to FIG. 1 in a total of three different operating states. The other injectors 18b, 18c, 18d illustrated in FIG. 1 have a similar structure and functionality.

Injector 18a has an electromagnetic actuator which has a solenoid 26 and an armature 30 which cooperates with solenoid 26. Armature 30 is connected to a valve needle 28 of injector 18a in such a way that the armature is movable with a nonvanishing mechanical play relative to valve needle 28 in relation to a direction of motion of valve needle 28 which is vertical in FIG. 2a.

This results in a two-part mass system 28, 30 which causes valve needle 28 to be driven by electromagnetic actuator 26, 30. This two-part configuration facilitates installation of injector 18a and reduces undesired rebound of valve needle 28 when it strikes its valve seat 38.

In the configuration illustrated in FIG. 2a, the axial play of armature 30 on valve needle 28 is limited by two stops 32 and 34. However, at least the lower stop 34 in FIG. 2a could also be implemented by a region of the housing of injector 18a.

As illustrated in FIG. 2a, valve needle 28 is acted on by a valve spring 36 with a corresponding elastic force against valve seat 38 in the region of housing 40. Injector 18a is shown in its open state in FIG. 2a. In this open state, armature 30 is moved upward in FIG. 2a as the result of current feed to solenoid 26, so that the armature moves valve needle 28 from its valve seat 38, against the elastic force, under engagement with stop 32. This allows fuel 42 to be injected by injector 18a into combustion chamber 20a (FIG. 1).

As soon as control unit 22 (FIG. 1) has stopped the feed current to solenoid 26, valve needle 28 moves toward its valve seat 38 under the action of the elastic force exerted by valve spring 36 and carries armature 30 with it. Force is transmitted from valve needle 28 to armature 30, once again via upper stop 32.

As soon as valve needle 28 has completed its closing motion upon striking valve seat 38, armature 30, as shown in FIG. 2b, is able to move farther downward in FIG. 2b due to the axial play until it rests against second stop 34 as illustrated in FIG. 2c.

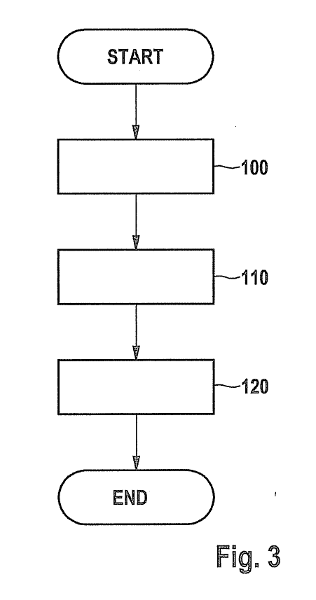

According to the present invention, the method which is described below with reference to the flow chart according to FIG. 3 is carried out in order to obtain information concerning an operating state of injector 18a.

At least one electrical operating variable of electromagnetic actuator 26, 30 is detected in a first step 100 of the method according to the present invention. This electrical operating variable may be, for example, an actuator voltage present at solenoid 26 or an actuator current flowing through solenoid 26.

According to the present invention, a variable which characterizes the acceleration of a movable component of electromagnetic actuator 26, 30, in particular armature 30 of the electromagnetic actuator, is formed in step 110 as a function of the at least one electrical operating variable of electromagnetic actuator 26, 30.

Lastly, an operating state of injector 18a is deduced in step 120 as a function of the variable which characterizes the acceleration.

The operating method according to the present invention may be used in particular for ascertaining an actual hydraulic closing point in time at which valve needle 28 (FIG. 2a) strikes its valve seat 38.

In a first preferred specific embodiment of the operating method according to the present invention, an actuator voltage u which is present at solenoid 26 is used as the electrical operating variable of the electromagnetic actuator, and first time derivative \dot{u} of actuator voltage u is formed and used as the variable which characterizes the acceleration of armature 30.

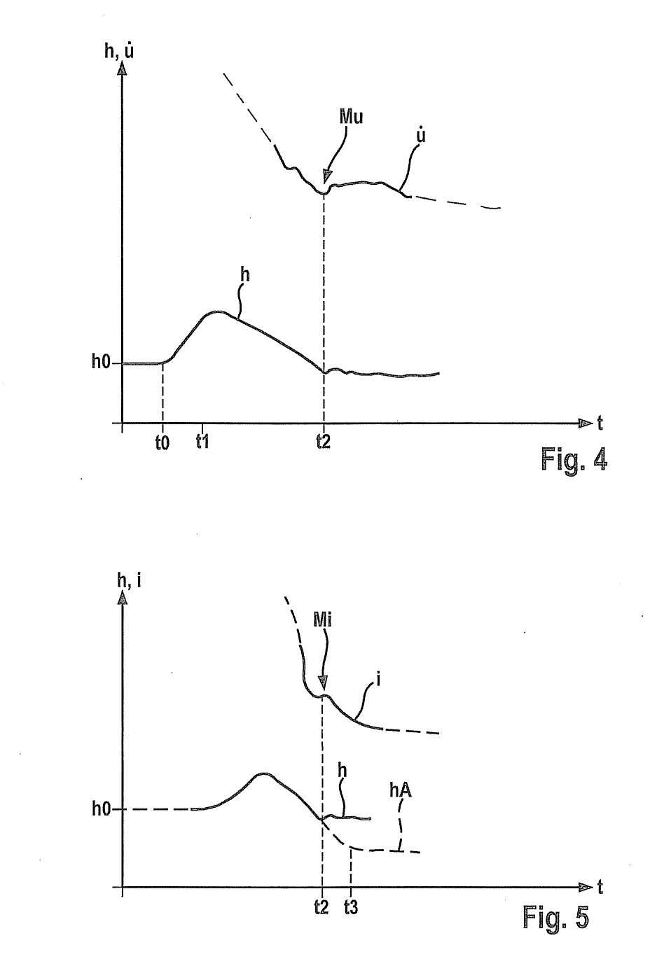

FIG. 4 shows an example of a simplified time curve of a needle lift h of valve needle 28 (FIG. 2a) and a corresponding detail of the time curve of first time derivative\dot{u} of actuator voltage u.

At point in time t0, valve needle 28 is lifted from its rest position on valve seat 38, denoted by needle lift value h0, which causes solenoid 26 to be appropriately fed with current and armature 30 to be moved upward in FIG. 2a, the armature carrying valve needle 28 with it under the transmission of force via stop 32.

At point in time t1 valve needle 28 has reached its maximum needle lift, and control unit 22 (FIG. 1) has stopped the current feed to solenoid 26. Magnetic force from solenoid 26 therefore no longer acts on armature 30, so that the mass system having valve needle 28 and armature 30 is moved downward in FIG. 2a under the action of the elastic force of valve spring 36. FIG. 4 accordingly shows a decreasing needle lift h for t>t1. When needle lift h begins to decrease after point in time t1, this results in an essentially exponential decay of first time derivative \dot{u} of actuator voltage u at solenoid 26.

According to the present invention, it has been recognized that, when valve needle 28 strikes its valve seat 38, first time derivative \dot{u} of actuator voltage u has a local minimum Mu which represents a clearly recognizable deviation from the otherwise exponential decay of first derivative \dot{u}.

Tests by the present applicant have shown that this local minimum Mu results when armature 30 detaches from valve needle 28 due to the nonvanishing mechanical play when valve needle 28 strikes its valve seat 38, and the armature initially moves farther in the closing direction, i.e., downward in FIG. 2b, before it strikes stop 34.

This means that after point in time t=t2 the elastic force exerted by valve spring 36 via stop 32 no longer acts on armature 30, resulting in an acceleration of armature 30 which is evaluated according to the present invention.

As described above, the change in the acceleration of armature 30 which occurs at point in time t2 results in a minimum Mu of first time derivative \dot{u} of actuator voltage u.

Accordingly, actual hydraulic closing point in time t2 of injector 18a (FIG. 2a) may be identified by evaluating first time derivative \dot{u} by control unit 22 (FIG. 1).

Particularly accurate detection of local minimum Mu is possible when an actuator current flowing through solenoid 26 is injected at a predefinable value, preferably a constant value, in particular zero, in the time range of interest around closing point in time t2.

For interference suppression and therefore more efficient signal processing, time derivative \dot{u} of actuator voltage u may also undergo filtering prior to the evaluation; it may be advantageous to carry out the differentiation of actuator voltage u and the filtering of the derived signal in one step, for example by filtering voltage signal u with the aid of a high-pass filter.

As an alternative to the above-described specific embodiment, the variable which characterizes the acceleration of armature 30 may also be formed according to the present invention as a function of actuator current i flowing through solenoid 26. In this case, first time derivative \dot{i} of actuator current i is used as the variable which characterizes the acceleration of armature 30.

FIG. 5 shows a time curve of needle lift h as previously described with reference to FIG. 4. In addition to needle lift curve h, lift curve hA of armature 30 is shown in dashed lines for point in time t2 at which valve needle 28 strikes in its closing motion valve seat 38 (FIG. 2a), in order to illustrate that after point in time t2 armature 30 initially moves farther in the closing direction, i.e., downward in FIG. 2b, before it strikes stop 34.

According to FIG. 5, armature 30 strikes stop 34 at point in time t3.

FIG. 5 also schematically shows a detail of the time curve of first time derivative \dot{i} of actuator current i considered according to the present invention. As is apparent from FIG. 5, first time derivative \dot{i} of actuator current i, which in the present case is used as the variable which characterizes the acceleration of armature 30, has a local maximum Mi, i.e., an inflection at point in time t2 at which valve needle 28 strikes valve seat 38.

Therefore, local maximum Mi, i.e., the inflection at point in time t2, may be analyzed and used according to the present invention as a criterion for the actual hydraulic closing of injector 18a.

Particularly precise evaluation of first time derivative \dot{i} of actuator current i is once again possible when actuator voltage u present at solenoid 26 of electromagnetic actuator 26, 30 is injected at a predefinable value, in particular zero.

For interference suppression and therefore more efficient signal processing, time derivative \dot{i} of actuator current i may also undergo filtering prior to the evaluation; it may be advantageous to carry out the differentiation of actuator current i and the filtering of the derived signal in one step, for example by filtering current signal i with the aid of a high-pass filter.

In another very advantageous specific embodiment of the method according to the present invention, a first electrical operating variable of electromagnetic actuator 26, 30 is detected and supplied to an observer element which simulates electromagnetic actuator 26, 30 without taking into account the effect that an armature motion has on electrical operating variables of the electromagnetic actuator, the observer element ascertaining an observed second electrical operating variable of the electromagnetic actuator. According to the present invention, the observed second electrical operating variable is compared to a detected second electrical operating variable, and the variable which characterizes the acceleration is ascertained as a function of the comparison result.

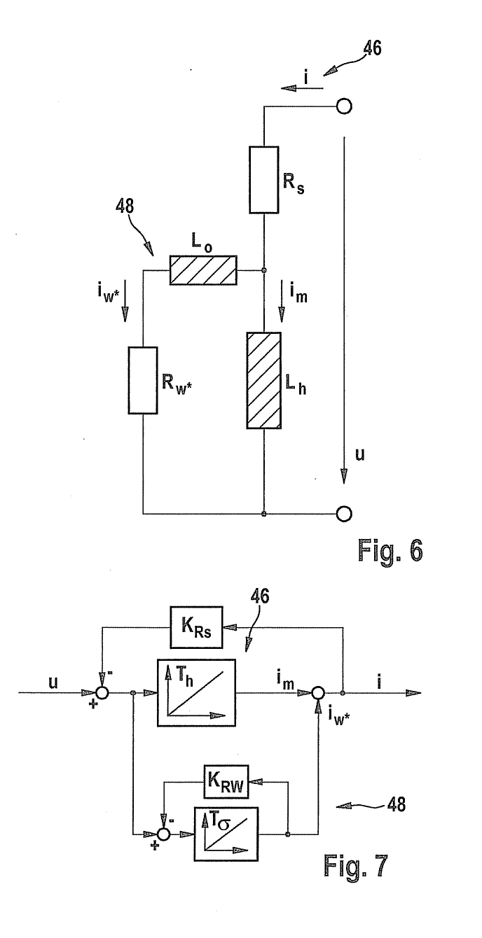

FIG. 6 shows a simplified equivalent circuit diagram of [electro]magnetic actuator 26, 30 (FIG. 2a), reference numeral 46 denoting a main current path and reference numeral 48 denoting an eddy current path. Resistor Rₛ represents a series resistor of solenoid 26 (FIG. 2a). Inductive elements Lₕ, Lₒ represent the inductance of main current path 46 and of eddy current path 48, respectively. Resistor R_{w*} represents an ohmic resistor of eddy current path 48.

Current iₘ, flows through the main current path, while current i_{w*} flows through eddy current path 48. Currents iₘ, i_{w*} together result in activating current i which acts on electromagnetic actuator 26, 30 via control unit 22. Actuator voltage u is present at the terminals of electromagnetic actuator 26, 30, as previously described.

FIG. 7 shows a block diagram which implements the function of the equivalent circuit diagram described above with reference to FIG. 6.

In the block diagram according to FIG. 7, eddy current path 48 is represented by an integrator, not described in greater detail, having time constant T_{σ}, and a proportional element associated therewith having amplification K_{Rw}.

In the block diagram according to FIG. 7, main current path 46 is represented by an integrator, not described in greater detail, having time constant Tₕ, and a proportional element associated therewith having amplification K_{Rs}.

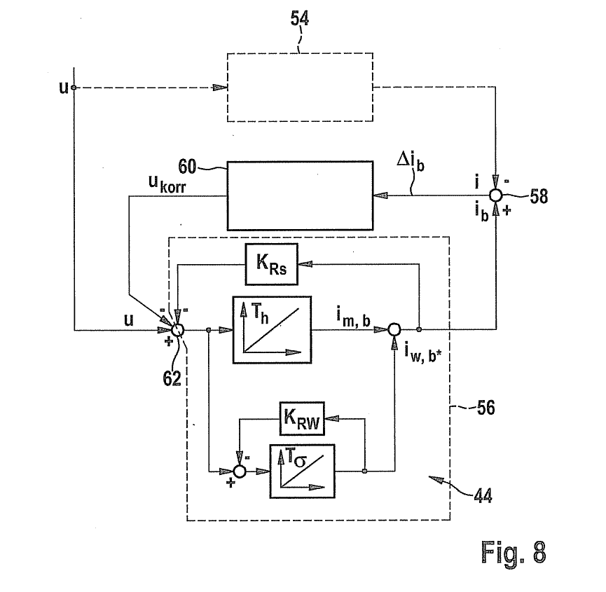

FIG. 8 shows a structure of observer element 56 according to the present invention, which on the input side is supplied with actuator voltage u as previously described, and which at its output outputs an observed actuator current ib. Adder 58 is used to make a comparison of observed actuator current ib and actual actuator current i, which is detected by measuring, for example, resulting in comparison result Δib. As is apparent from FIG. 8, comparison result Δib is supplied to feedback element 60, which forms an output variable uₖₒᵣᵣ therefrom which is subtracted from detected actuator voltage u by adder 62.

Feedback element 60 may be designed, for example, as a proportional element, a proportional-integral element, or also as a higher-order feedback element and/or a more complex structure.

As the result of subtracting output variable uₖₒᵣᵣ current ib which is observed using observer element 56 is corrected to current i, which is detected by measuring. Since the difference between actual electromagnetic actuator 26, 30 and the representation shown in FIG. 8 of a corresponding controlled system in observer element 56 represents a lack of reaction of the armature motion, output variable uₖₒᵣᵣ simulates this exact reaction, this reaction being proportional to the speed of armature 30. At the point in time when injector 18a closes (FIG. 2a), an abrupt change in the speed of armature 30 does not occur as previously described, but, rather, only of valve needle 28.

However, at the point in time when the valve closes, a comparatively great change in the first time derivative of output variable uₖₒᵣᵣ occurs.

Tests by the present applicant have shown that the gradient of output variable uₖₒᵣᵣ at closing point in time t2 (FIG. 4) is usually subject to a change of sign, resulting in an extreme in the time curve of output variable uₖₒᵣᵣ. This extreme is detected according to the present invention and used as a signal for closing point in time t2 of injector 18a.

The behavior of the transmission between the speed of armature 30 and output variable uₖₒᵣᵣ may be influenced by appropriate parameterization of feedback element 60 (FIG. 8). In particular, interference signals may be filtered in this way, resulting in an even more accurate evaluation.

The method described with reference to FIGS. 6, 7, 8 advantageously operates independently of an actual actuator current i, an actuator voltage u, or an application of one or both of these variables, and in particular also independently of an operative relationship which may be present between the two variables u, i.

Instead of output variable uₖₒᵣᵣ of feedback element 60, an internal variable of feedback element 60 may be used for detecting closing point in time t2 (FIG. 4). If feedback element 60 is designed as a proportional-integral element, for example, instead of output variable uₖₒᵣᵣ the integral portion of the feedback variable, for example, may be used alone.

If less stringent requirements are imposed on the significance of output signal uₖₒᵣᵣ with regard to closing point in time t2, leakage path 48 of the equivalent circuit diagram illustrated in FIG. 6 may also be disregarded, resulting in a simpler evaluation.

According to the present invention, it is also possible to take into account multiple different eddy current paths, each having a different commutation inductance with respect to solenoid 26. For this purpose, in the block diagram according to FIG. 7, in addition to main current path 48 further current paths may be connected in parallel, each of which may be provided with different integrator and feedback element parameters.

It is also possible to take into account nonlinear relationships between the observed variables in observer element 56 used according to the present invention (FIG. 8), thus allowing saturation and hysteresis effects of an actual magnetic circuit or electromagnetic actuator 26, 30 to be taken into consideration.

Besides using the operating method according to the present invention for detecting the closing time of such injectors 18a which have a complex mass system 28, 30 for valve activation, the method according to the present invention is also suitable for detecting the closing time of conventional injectors having a rigid coupling between the electromagnetic actuator and the valve needle.

Observer element 56 described with reference to FIG. 8 may have a digital or also an analog design, and is preferably implemented in a computing unit of control unit 22 (FIG. 1).

In addition to accurate detection of closing point in time t2 (FIG. 4), the operating method according to the present invention also allows the recognition of other operating states or state transitions of injector 18a (FIG. 2a) which accompany a corresponding characteristic change in the acceleration of armature 30.

As an alternative or in addition to the above-described consideration of local extremes of the variables which characterize the acceleration, a time curve of the variables which characterize the acceleration may be compared to a predefined reference curve or also to identify other features, for example an inflection in the time curve, or the like.

The information obtained according to the present invention is particularly preferably used for regulating an operation of injectors 18a, . . . 18d.

1-13. (canceled)

14. A method for operating an injector of an internal combustion engine of a motor vehicle, in which a valve needle component of the injector is driven with the aid of an electromagnetic actuator, comprising:
forming a variable which characterizes the acceleration of a movable armature component of the electromagnetic actuator as a function of at least one electrical operating variable of the electromagnetic actuator, and deducing an operating state of the injector as a function of the variable which characterizes the acceleration, the valve needle being acted on by elastic force, and the armature being connected to the valve needle in such a way that the armature is movable with a nonvanishing mechanical play relative to the valve needle in relation to a direction of motion of the valve needle, and based on a characteristic feature of the variable which characterizes the acceleration of the armature it is deduced that the armature detaches from the valve needle.

15. The method as recited in claim 14, wherein an actuator voltage which is present at a solenoid of the electromagnetic actuator is used as the electrical operating variable of the electromagnetic actuator, and the first time derivative of the actuator voltage is formed as the variable which characterizes the acceleration of the armature.

16. The method as recited in claim 15, wherein based on the appearance of a local minimum of the first time derivative of the actuator voltage it is deduced that the armature detaches from the valve needle.

17. The method as recited in claim 14, wherein an actuator current which flows through the solenoid is injected at a predefinable value.

18. The method as recited in claim 14, wherein an actuator current which flows through a solenoid of the electromagnetic actuator is used as the electrical operating variable of the electromagnetic actuator, and the first time derivative of the actuator current is formed as the variable which characterizes the acceleration of the armature.

19. The method as recited in claim 18, wherein based on the appearance of a local maximum of the first time derivative of the actuator current it is deduced that the armature detaches from the valve needle.

20. The method as recited in claim 14, wherein an actuator voltage which is present at the solenoid of the electromagnetic actuator is injected at a predefinable value.

21. The method as recited in claim 14, wherein a first electrical operating variable of the electromagnetic actuator is detected and supplied to an observer element which simulates the electromagnetic actuator without taking into account the reaction that an armature motion has on electrical operating variables of the electromagnetic actuator, the observer element ascertaining an observed second electrical operating variable of the electromagnetic actuator, and the observed second electrical operating variable being compared to a detected second electrical operating variable, and the variable which characterizes the acceleration being ascertained as a function of the comparison result.

22. The method as recited in claim 15, wherein the first time derivative of the actuator voltage undergoes filtering by a filter element prior to a further evaluation.

23. The method as recited in claim 22, wherein a formation of the first time derivative and the filtering take place in one step with the aid of a high-pass filter.

24. The method as recited in claim 17, wherein the first time derivative of the actuator current undergoes filtering by a filter element prior to a further evaluation.

25. The method as recited in claim 24, wherein a formation of the first time derivative and the filtering take place in one step with the aid of a high-pass filter.

26. The method as recited in claim 14, wherein the elastic force acts on the valve needle in a closing direction of the valve needle.

27. The method as recited in claim 17, wherein the predefined value is zero.

28. The method as recited in claim 20, wherein the predefined value is zero.

29. A non-transitory computer-readable data storage medium storing a computer program having program codes which, when executed on a computer, performs a method for operating an injector of an internal combustion engine of a motor vehicle, in which a valve needle component of the injector is driven with the aid of an electromagnetic actuator, the method comprising:
forming a variable which characterizes the acceleration of a movable armature component of the electromagnetic actuator as a function of at least one electrical operating variable of the electromagnetic actuator, and deducing an operating state of the injector as a function of the variable which characterizes the acceleration, the valve needle being acted on by elastic force, and the armature being connected to the valve needle in such a way that the armature is movable with a nonvanishing mechanical play relative to the valve needle in relation to a direction of motion of the valve needle, and based on a characteristic feature of the variable which characterizes the acceleration of the armature it is deduced that the armature detaches from the valve needle.
